(19) United States
(12) Patent Application Publication
(10) Pub. No.: US 2008/0046461 A1
(43) Pub. Date: Feb. 21, 2008

(54) Method and apparatus for generating a web page

(75) Inventor: Kiyohiko Narazaki, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD., Tokyo (JP)

(21) Appl. No.: 11/907,321

(22) Filed: Oct. 11, 2007

Related U.S. Application Data
(63) Continuation of application No. 10/838,524, filed on May 5, 2004.

(30) Foreign Application Priority Data
Jun. 13, 2003 (JP) 2003-169498

(51) Int. Cl. G06F 17/30

(52) U.S. Cl. 707/102; 707/E17.001

(57) ABSTRACT

On receiving a page request from a WWW browser of a user, a WWW server acquires a previously generated fixed page and transmits the fixed page to the WWW browser as a reply. The browser displays the fixed page received from the WWW server and transmits a request for a dynamic page to the WWW server according to a process which has been embedded in the fixed page. The WWW server which received the dynamic page request from the WWW browser runs a dynamic page generation program, requesting the dynamic page generation program to generate the dynamic page. The dynamic page generation program generates the dynamic page from a template and the latest data stored in a database. The WWW server transmits the generated dynamic page to the WWW browser as a reply to the dynamic page request.

### INCORPORATION BY REFERENCE

The present application claims priority from Japanese application JP 2003-169498 filed on Jun. 13, 2003, the content of which is hereby incorporated by reference into this application.

### BACKGROUND OF THE INVENTION

The present invention relates to a method and apparatus for generating a Web page, and in particular, to a method and apparatus for generating a Web page which is used in the WWW (World Wide Web).

Web pages (hereinafter, also abbreviated as “pages”) which are used in the WWW can be generated by existing techniques, by use of a proxy server and the push technology, by which fixed pages (pages having fixed or stationary contents) can be displayed on the browser at high speed. Meanwhile, as a conventional technique for generating a dynamically generated page at high speed by preserving the latest status of the dynamically generated page so that the dynamically generated page can be handled as a fixed page, a technique disclosed in JP-A-2000-250841 is known, for example.

### SUMMARY OF THE INVENTION

In the conventional technique for speeding up the generation of the dynamic pages, a new page is generated every time when data used for the page generation are updated. Therefore, it is difficult to employ the technique in cases where the data for the page generation are updated frequently.

Further, in the conventional technique, the dynamic pages have to be generated page by page for each page request. Therefore, speeding-up techniques can not be used and the acquisition of a page takes a long time.

It is therefore the primary object of the present invention to provide a method and apparatus for generating a Web page by which the problems of the above conventional techniques can be resolved, high speed generation of dynamically generated WWW pages can be realized, and the time necessary for displaying the pages can be shortened even when the data to be used for generating the pages are updated frequently.

In accordance with an aspect of the present invention, there is provided a page generation method for receiving a page request and generating a page requested in response to a reception of the page request based on a template and page element data necessary for the page generation, comprising the steps of: generating a fixed page that contains stationary elements of the template and a request for a dynamic page; and transmitting the fixed page as a reply to the page request.

In accordance with another aspect of the present invention, there is provided a page generation method for receiving a page request and generating a page requested by the page request from a template and page element data necessary for the page generation, comprising the steps of: generating a fixed page that contains stationary elements of the template and a request for a dynamic page in response to the page request; and transmitting the generated fixed page as a reply to the page request.

In accordance with another aspect of the present invention, there is provided a page generation apparatus for receiving a page request and generating a page requested by the page request from a template and page element data necessary for the page generation, comprising: a fixed page generation module which generates a fixed page that contains stationary elements of the template and a request for a dynamic page; and a reply module which transmits the fixed page as a reply to the page request.

In accordance with another aspect of the present invention, there is provided a page generation apparatus for receiving a page request and generating a page requested by the page request from a template and page element data necessary for the page generation, comprising: a fixed page generation module which generates a fixed page that contains stationary elements of the template and a request for a dynamic page in response to the page request; and a reply module which transmits the fixed page as a reply to the page request.

In accordance with another aspect of the present invention, there is provided a page generation program for instructing a computer to execute a process for generating a page according to a page request. The page generation process comprises the steps of: receiving a page request; generating a fixed page that contains stationary elements of a template and a request for a dynamic page; transmitting the generated fixed page; receiving a request for the dynamic page based on the request contained in the fixed page; generating the dynamic page that contains dynamic information required by the fixed page; and transmitting the generated dynamic page as a reply to the request for the dynamic page.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing the composition of a WWW system employing a page generation method and page generation apparatus in accordance with an embodiment of the present invention;

FIG. 2 is a sequence diagram explaining the overall operation of the WWW system of FIG. 1 in terms of data flow;

FIG. 3 is a flow chart explaining a page generation process conducted by a server computer according to the page generation method of the embodiment;

FIG. 4 is a sequence diagram explaining another example of the overall operation of the WWW system of FIG. 1 in terms of data flow;

FIG. 5 is a schematic diagram explaining an example of the description of a template which is used for generating pages according to the embodiment of the present invention;

FIG. 6 is a schematic diagram showing an example of a fixed page 11 which is generated from the template of FIG. 5 and displayed on a WWW browser; and

FIG. 7 is a schematic diagram showing an example of a dynamic page which is generated from the template of FIG. 5 and displayed on the WWW browser.

### DESCRIPTION OF THE EMBODIMENTS

Referring now to the drawings, a description will be given in detail of preferred embodiments in accordance with the present invention.

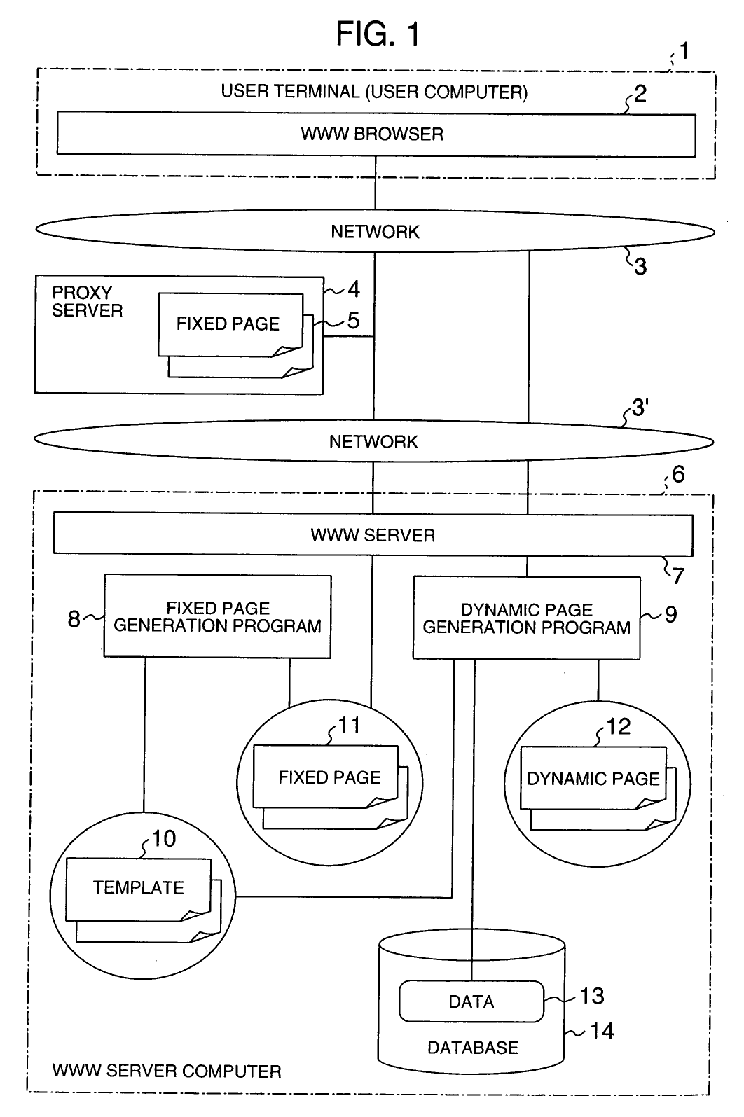

FIG. 1 is a block diagram showing the composition of a WWW system employing a page generation method and page generation apparatus in accordance with an embodiment of the present invention. In FIG. 1, the reference numeral “1” denotes a computer of a user, “2” denotes a WWW browser, “3” and “3′” denote networks, “4” denotes a proxy server, “5” and “11” denote fixed pages, “6” denotes a server computer, “7” denotes a WWW server, “8” denotes a fixed page generation program, “9” denotes a dynamic page generation program, “10” denote a template, “12” denotes a dynamic page, “13” denotes page element data, and “14” denotes a database.

The WWW system to which the embodiment of the present invention is applied is mainly composed of the computer 1 (personal computer, for example) of the user requesting a WWW page and the server computer 6 (for carrying out a WWW page server process) which are connected together by the networks 3 and 3′. The computer 1 of the user (hereinafter, also referred to as a “user computer 1”) is equipped with the WWW browser 2 as software for requesting and displaying WWW pages. By the functions of the WWW browser 2, the user computer 1 requests WWW pages, receives the WWW pages and displays the received WWW pages. The networks 3 and 3′ are used for the transmission of the page requests of the user to the server computer 6 and the transmission of generated pages to the user computer 1. In the case of the WWW, the data are communicated according to the HTTP (HyperText Transport Protocol). In the example shown in FIG. 1, the network 3 can be, for example, an office LAN, and the network 3′ can be a WAN (Wide Area Network). The networks 3 and 3′ may also be implemented by one network.

The server computer 6 is the apparatus for carrying out the page generation process according to the embodiment of the present invention. The server computer 6 includes the WWW server 7 for judging and interpreting the page request sent from the user computer 1 and returns a page or issues a page generation request, the fixed page generation program 8 as software for generating the fixed pages 11 from the template 10, the database 14, and the dynamic page generation program 9 as software for generating the dynamic pages 12 from the template 10 and the page element data 13 stored in the database 14.

While the proxy server 4 for preserving the fixed pages 5 is connected between the networks 3 and 3′ in the example of FIG. 1, the proxy server 4 is not particularly necessary for this embodiment. However, by providing the proxy server 4 to the system and letting the proxy server 4 preserve the fixed pages 5 generated by a process which will be described later, fixed pages requested by the user can be sent to the user computer 1 at high speed if the requested fixed pages have already been preserved in the proxy server 4, similarly to the cases of conventional techniques.

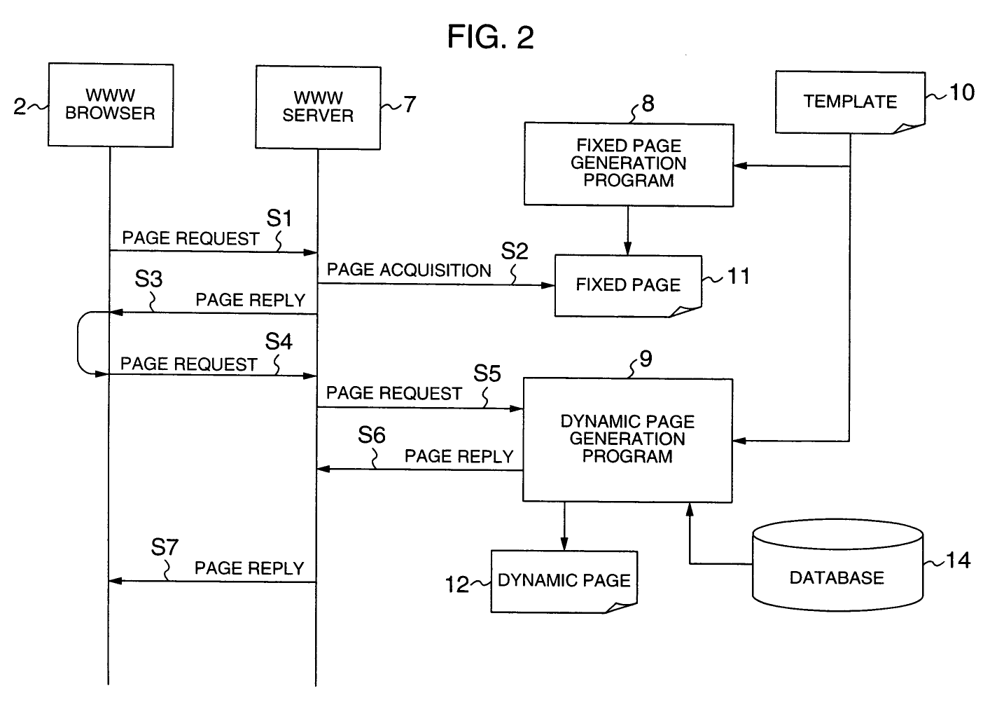

FIG. 2 is a sequence diagram explaining the overall operation of the WWW system of FIG. 1 in terms of data flow. In the following, the operation of the whole WWW system will be described referring to FIG. 2.

The server computer 6 generates a fixed page 11 in advance from the template 10 by executing the fixed page generation program 8. When a page request (S1) sent from the WWW browser 2 of the user computer 1 is received by the WWW server 7, the WWW server 7 acquires (S2) the previously generated fixed page 11 and transmits the fixed page 11 to the user computer 1 as a reply (S4) to the page request. The WWW browser 2 receives the fixed page 11 as a reply from the WWW server 7, displays the received fixed page 11, and transmits a request (S4) for a dynamic page to the server computer 6 (WWW server 7) according to a process embedded in the fixed page 11. The WWW server 7 which received the page request from the WWW browser 2 requests (S5) a page from the dynamic page generation program 9. The server computer 6 runs the dynamic page generation program 9 and lets the dynamic page generation program 9 generate a dynamic page 12 from the template 10 and the latest data in the database 14. The WWW server 7 receives the generated dynamic page 12 as a reply (S6) from the dynamic page generation program 9, and transmits the dynamic page 12 to the WWW browser 2 of the user computer 1 as a reply (S7) to the dynamic page request. The WWW browser 2 receives the dynamic page 12 from the WWW server 7 and displays the dynamic page 12.

Incidentally, the dynamic page 12 explained above is generated so as to contain all the contents of the fixed page 11.

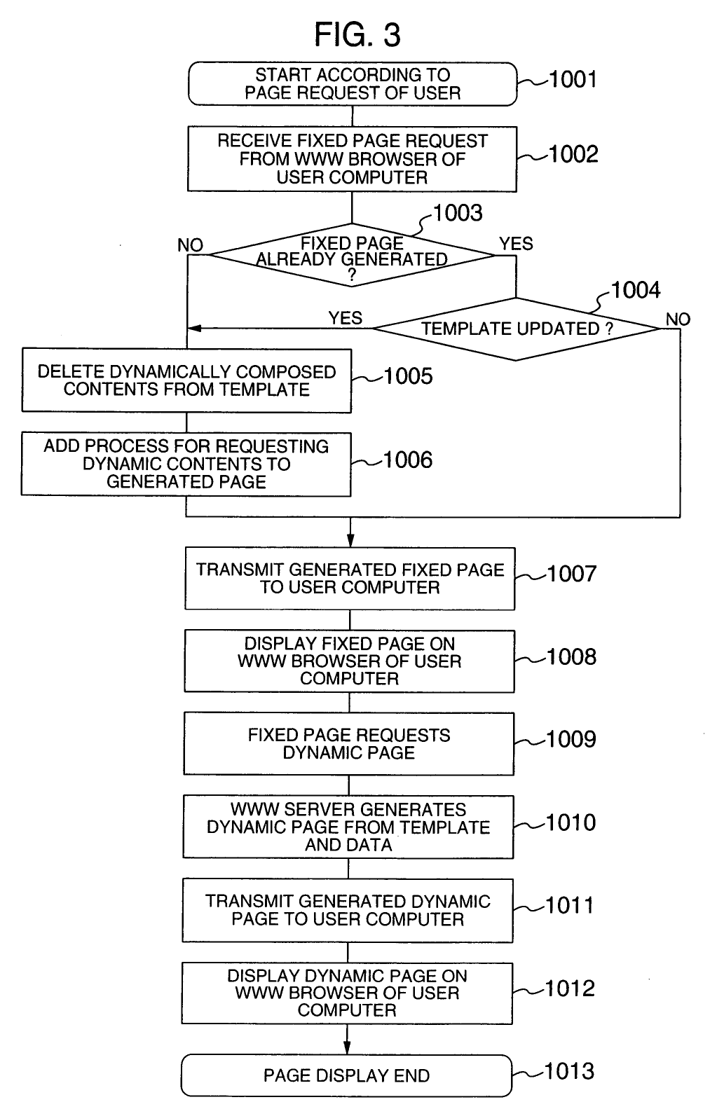

FIG. 3 is a flow chart explaining a page generation process which is conducted by the server computer 6 according to the page generation method of this embodiment. The page generation process will be explained below.

(1) The process is started according to a page request supplied from the WWW browser 2 of the user computer. First, a request for a fixed page 11 sent from the WWW browser 2 of the user computer 1 is received (step 1001, step 1002).

(2) The server computer 6 which received the request for the fixed page 11 judges whether the fixed page 11 has already been generated or not (step 1003). If the fixed page 11 has already been generated (1003: YES), the server computer 6 judges whether or not the template that was used for generating the fixed page 11 has been updated (step 1004).

(3) If the fixed page 11 has not been generated yet (1003: NO) or if the template that was used for generating the fixed page 11 has been updated (1004: YES), the server computer 6 newly generates a fixed page containing stationary (fixed) elements and a request for a dynamic page, by generating a fixed page by deleting dynamically composed contents from the template 10 and adding a process for requesting dynamic contents to the generated fixed page (step 1005, step 1006).

(4) Meanwhile, if the template that was used for generating the fixed page 11 has not been updated (1004: NO), the server computer 6 transmits the already-generated fixed page 11 to the user computer 1, otherwise the server computer 6 transmits the fixed page 11 generated by the steps 1005 and 1006 to the user computer 1 (step 1007).

(5) The user computer 1 lets the WWW browser 2 display the fixed page 11 sent from the server computer 6 and makes a request for a dynamically generated page according to the process embedded in the fixed page 11 (step 1008, step 1009).

(6) The server computer 6 which received the request for the dynamic page from the user computer 1 lets the WWW server 7 generate the latest dynamic page 12 based on the template 10 and the page element data 13 stored in the database 14 and then transmits the generated dynamic page 12 to the user computer 1 (step 1010, step 1011).

(7) The user computer 1 receives the dynamic page 12 and lets the WWW browser 2 display the page, by which a series of steps for displaying the page is completed (step 1012, step 1013).

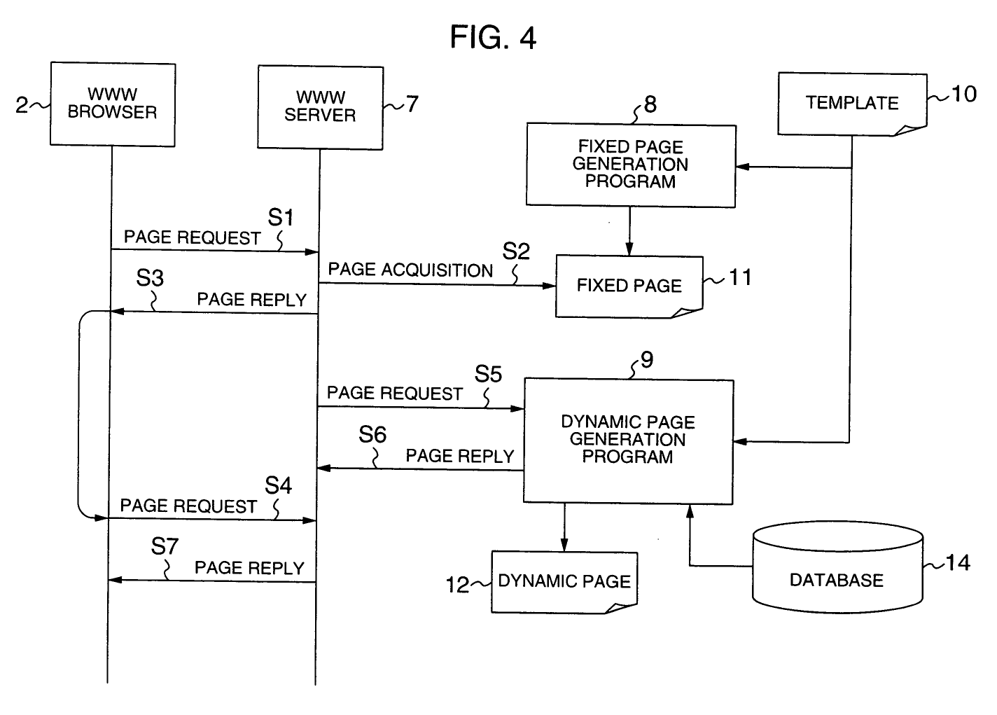

FIG. 4 is a sequence diagram explaining another example of the overall operation of the WWW system of FIG. 1 in terms of data flow. In the following, only the points different from the example of FIG. 2 will be explained.

The dynamic page 12 was generated (S5, S6) after the user computer 1 made the request (S4) for the dynamic page in the example of FIG. 2. However, in the example of FIG. 4, the dynamic page 12 is generated (S5, S6) at the point when the fixed page 11 is transmitted (S3) to the WWW browser 2 of the user computer 1 in response to the request for the fixed page 11, by which it becomes possible for the WWW server 7 to transmit (S7) the dynamic page 12 to the WWW browser 2 immediately after the arrival of the dynamic page request (S4) and thereby the time for the response to the dynamic page request can be shortened considerably.

Each of the aforementioned processes according to the embodiment of the present invention can be implemented by a processing program. Such a processing program can be stored and supplied in various record mediums such as an HD, DAT, FD, MO, DVD-ROM or CD-ROM.

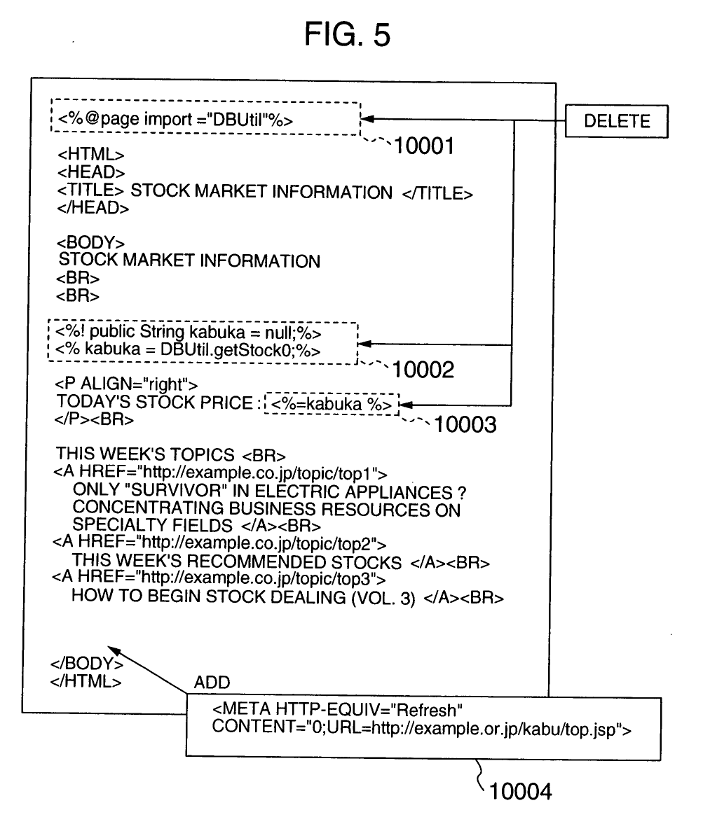

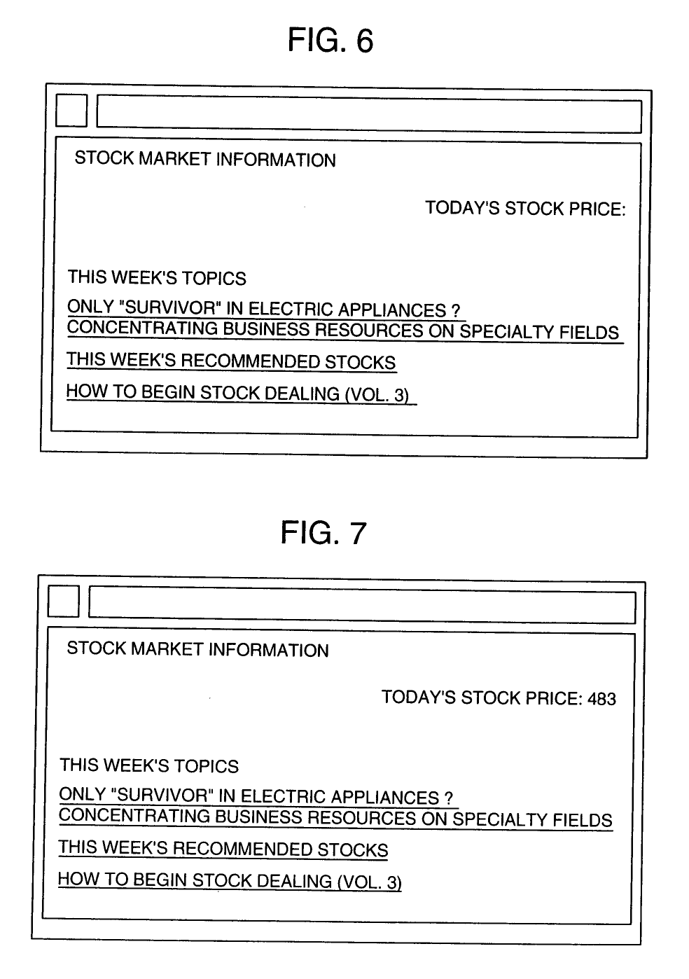

FIG. 5 is a schematic diagram explaining an example of the description of the template 10 which is used for generating the pages according to the embodiment of the present invention. FIG. 6 is a schematic diagram showing an example of a fixed page 11 which is generated from the template 10 of FIG. 5 and displayed on the WWW browser 2. FIG. 7 is a schematic diagram showing an example of a dynamic page 12 which is generated from the template 10 of FIG. 5 and displayed on the WWW browser 2.

In the example of FIG. 5, parts indicated with reference numerals 10001-10003 are scripts for generating dynamic pages, and the other part describes information as stationary elements, that is, information to be displayed in the fixed page. In this example, the latest stock price (today's stock price in the example) is acquired from the database by use of the information of the scripts 10001 and 10002 and is embedded in the script 10003. The dynamic page is generated by embedding the stock price as dynamic information in the script 10003.

In the processes of this embodiment which have been explained referring to FIGS. 1-4, when the server computer 6 generates a fixed page 11, the fixed page generation program 8 is run by the server computer 6, by which the scripts 10001-10003 are deleted from the template 10 and a dynamic content request process 10004 (as a request for a dynamic page) is added to the template 10 and thereby the fixed page 11 is completed. The dynamic content request process 10004 is configured to include the page address of the dynamic page 12.

Meanwhile, when the server computer 6 generates a dynamic page 12, the dynamic page generation program 9 is run by the server computer 6, by which the dynamic page 12 is generated by interpreting the scripts 10001 and 10002 of the template 10 and acquiring the information to be embedded in the script 10003 by use of the latest data in the database 14.

The fixed page 11 generated from the aforementioned template example of FIG. 5 is displayed on the WWW browser 2 as shown in FIG. 6. While the fixed page 11 of the example of FIG. 6 is a page for displaying stock market information, information on “today's stock price” that varies and fluctuates has not been displayed yet in the fixed page 11. When the dynamic page 12 is generated, the page looks like the one shown in FIG. 7, in which the actual value of the stock price is displayed as the “today's stock price” information.

By the embodiment of the present invention which has been described above, in the access to a dynamic page, the time necessary for starting displaying the page on the browser can be shortened and the fixed page (as stationary parts of the dynamic page) can be acquired in a short time, by which waiting time of users can be reduced considerably. Further, figures, links to other pages, etc. in the page can be obtained before the completion of the page generation, therefore, the time necessary for the display of dynamically composed pages can be shortened.

As set forth hereinabove, by the page generation method and page generation apparatus in accordance with the present invention, high speed generation of dynamically generated WWW pages can be realized and the time necessary for displaying the pages can be shortened even when the data to be used for generating the pages are updated frequently.

The present invention can be applied not only to the web page showing stock market information but also to other various web pages, such as for ticket reservations, stock control systems, and banner advertising.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A page generation method for receiving a page request and generating a page requested by the page request from a template and page element data necessary for the page generation, comprising the steps of:
generating a fixed page that contains stationary elements of the template and a request for a dynamic page; and
transmitting the fixed page as a reply to the page request.

2-13. (canceled)
